(19) United States
(12) Patent Application Publication
(10) Pub. No.: US 2008/0276877 A1
(43) Pub. Date: Nov. 13, 2008

(54) FEED FOR FISH AND USE THEREOF

(75) Inventors: Francis CHI, Hong Kong (HK); Qin Tang WEN, Hong Kong (HK); Tian Shui LU, Hong Kong (HK)

Correspondence Address: WILLIAM J. SAPONE;COLEMAN SUDOL SAPONE P.C., 714 COLORADO AVENUE, BRIDGE PORT, CT, 06605, US

(73) Assignee: WALCOM ANIMAL SCIENCE (I.P.3) LIMITED, Hong Kong (HK)

(21) Appl. No.: 12/177,942

(22) Filed: Jul. 23, 2008

Related U.S. Application Data
(62) Division of application No. 10/504,257, filed on Sep. 17, 2004.

(30) Foreign Application Priority Data
Feb. 20, 2002 (GB) 0203991.5

(51) Int. Cl. A01K 61/00

(52) U.S. Cl. 119/230

(57) ABSTRACT

A fish feeding composition for improving the growth and/or health of fish, comprises cysteamine or salts thereof and from 1 to 80 wt % of a carrier. The fish feeding composition is preferably added to a basal feed and then fed to the fish. Use of such a feed increases body weight and reduces death due to disease and adverse living conditions.

### CROSS REFERENCE TO RELATED APPLICATIONS

This application is a division of U.S. patent application Ser. No. 10/504,257, filed 10 Aug. 2004, which was a National Stage filing based on International Patent Application no. PCT/EP03/01733, filed 20 Feb. 2003.

### FIELD OF INVENTION

The present invention relates to the use of cysteamine or its salt like compounds, and/or a cysteamine-containing composition for raising aquatic animals, and in particular vertebrate aquatic animals, and more particularly fish in aquaculture. The present invention also relates to methods of raising fish, a feed for fish, and a method of preparing such a feed.

### BACKGROUND OF THE INVENTION

It has long been established that growth hormones play an important role in regulating growth of animals. For instance, administering growth hormones in meat producing animals will increase their body weight including their muscle mass. However, there are a number of disadvantages in using growth hormones directly in increasing meat production in these animals. Firstly, growth hormones from different animals are seldom homogenous and different animals only react to certain types of specific growth hormones. Since suitable exogenous growth hormones are normally extracted from pituitary glands, it is rather difficult and uneconomical to prepare a sufficient quantity of suitable exogenous growth hormones for use on a large-scale application. Although exogenous growth hormones can now be prepared using DNA recombinant technology, exogenous growth hormones manufactured by such a method are still rather expensive. Secondly, the administration of exogenous growth hormones into farm animals is normally performed by direct injection, which is inevitably rather costly and difficult to administer in a large farm such as a cattle farm. Administering exogenous growth hormones into fish in aquaculture is even more difficult as catching and monitoring individual fish on a regular basis and injecting them with a suitable growth hormone is virtually impossible. Thirdly, it is rather difficult to control the dose administered to produce precisely the desired effect, and an overdose of exogenous growth hormones is likely to be harmful to the animals. Fourthly, residuals of these exogenous growth hormones may be passed to the meat products and subsequently to humans through consumption thereof. Further studies in this regard are required although some scientists are concerned about the negative side effects of these exogenous growth hormones to humans.

In view of the rapidly growing human population, there is an increasing demand for many types of food products including seafood products and in particular fish. Recent estimates by the United Nations indicate that the current supply of seafood products will have to increase seven-fold in order to meet the worldwide demand for seafood products. Given the rapid decline in world fish stocks caused mainly by over fishing and destruction of habitats of fish, it is clear that demand can only be met by aquaculture. However, production of aquacultural products of many fish species is challenged or handicapped by several factors. These include the difficulties in the selection and supply of suitable breed stock, enhancing the growth rate and feed conversion efficiency in raising fish, controlling the feeding costs, managing the reproductive cycle, and preventing diseases.

In order to raise fish in aquaculture so that body weight thereof can increase rapidly, one conventional method was to administer exogenous growth hormones into the fish. However, as explained above, administering exogenous growth hormones into fish is very difficult if not impossible.

One alternative is to produce desired breed stocks of fish by cross breeding to enhance the beneficial traits of the fish. However, these traits are generally rather slow to emerge and unpredictable. Despite cross breeding, the fish genome often still does not contain the desired genes mediating the intended effects.

Yet another alternative to traditional methods of selection and breeding is to use modern genetic engineering to produce transgenic fish which can grow rapidly. In particular, transgenic fish can be produced by identifying, isolating and constructing the genes responsible for desirable traits using molecular biology and then transferring these genes to the breed stocks. With this modern technology, new traits that are not present in a fish genome can be transferred thereto from an unrelated species, enabling the production of new and beneficial phenotypes. However, genetic engineering of transgenic fish suffers a number drawbacks. Firstly, there is widespread concern on the negative impact of consuming genetically modified (GM) food in general. A large-scale production of transgenic fish for human consumption inevitably will have immense legal and social implications. Secondly, engineering a genetic modified breed stock for each fish type currently consumed by humans is economically impracticable. Thirdly, transgenic fish which are supposed to be raised in captivity, if accidentally allowed to escape into the wild, would grow rapidly because of their improved general adaptability to the environment and would undesirably crowd out their unmodified relatives. This would not only upset the ecosystem in an unimaginable way, but also pollute the genome of the relevant species in nature. Such crowding out of natural stocks and genome pollution has already been seen in at least salmon. Transgenic salmon are often at least twice as large in size and weight, and can survive remarkably better. Crossbreeding of transgenic salmons and natural salmons has already polluted the salmons' genome in the wild.

Cysteamine is a component of co-enzyme A and works as a physiological regulator. Cysteamine has been used as an additive in feed in promoting growth of meat producing mammals. U.S. Pat. No. 4,711,897 discloses animal feed methods and feed compositions comprising cysteamine. However, it has been identified that cysteamine is a fairly sensitive and unstable compound under normal room temperature conditions. For example, cysteamine is readily oxidized when exposed to air or at an elevated temperature. Cysteamine is highly hydroscopic. Also, cysteamine is unpalatable when taken directly by mouth. Further, ingesting cysteamine directly will cause undesirable gastro side effects. For these reasons, the use of cysteamine had for a long time been limited to direct injection of cysteamine-containing solution into meat producing animals.

Therefore, there continues to exist a need for a composition and/or method for improving growth and/or health of fish, and in particular increasing body weight and/or reducing death rate of fish in aquaculture. Preferably, the method is safe, can be easily administered and inexpensive to carry out, and environmentally friendly.

It is thus an object of the present invention in which the above issues are addressed, or at least to provide a useful alternative to the public.

### SUMMARY OF THE INVENTION

According to a first aspect of the present invention, there is provided the use of a cysteamine-containing composition for feeding fish for improving growth and/or health thereof, wherein the composition comprises substantially 1 to 80 wt % of a carrier. In particular, the use may be for increasing body weight thereof. The use may also be for reducing death rate thereof due to diseases or adverse living conditions.

Preferably, the cysteamine-containing composition may be fed to the fish via a final feed. However, the cysteamine-containing composition may also be administered to the fish by other suitable means independent of any feed.

Suitably, the composition may comprise substantially 1 to 95 wt % cysteamine having the chemical formula of NH₂—CH₂—CH₂—SH or its salt-like compounds.

The composition may comprise substantially 30 wt % cysteamine or its salt-like compounds. The carrier, also serving as a stabilizer and may be referred as an inclusion compound host materials composition, may be selected from a group including cyclodextrin or its derivatives. The composition may comprise 10 wt % of the carrier.

The composition may comprise ingredient(s) selected from a group including a bulking agent, a disintegrant and a material for providing coating to the composition. The coating material may be in a solid state at room temperature conditions. The coating material may be enteric and soluble only in the intestines of the fish. The coating may exhibit a multi-layer structure in the composition. The coating may be adapted to remain un-dissolved at pH 1.5 to 3.5.

The final feed may comprise feed concentrate and/or feed supplement. The final feed may comprise a suitable basal feed selected from a group including rape seed, cotton seed, soybean, fish meal, wheat bran, wheat feed meal, minerals, vitamins and binders. The final feed may comprise substantially 30 to 150 ppm of cysteamine. The final feed may comprise substantially 100 to 500 ppm of the composition. They final feed in its dried state may comprise substantially 33 to 165 ppm of cysteamine. The final feed in its dried state may comprise substantially 110 to 550 ppm of the composition.

According to a second aspect of the present invention, there is provided a method of raising fish comprising steps mixing a cysteamine-containing composition (described above) with a suitable basal feed (also described above), and feeding the fish with a final feed resulting from the mixing.

Preferably, the mixing may comprise directly mixing the composition with the basal feed. Alternatively, the mixing may comprise steps of preparing a premix material including the cysteamine-containing composition, and subsequently mixing the premix material with the basal feed forming the final feed. The premix material may be prepared by mixing the composition with a suitable food material. The use of the premix material as an intermediate mixer will facilitate the mixing so that the composition may be more evenly distributed in the final feed. The premix material may have a content of 1 to 25 wt % of the composition. Preferably, the premix material may have a content of 10 to 20 wt % of the composition.

According to a third aspect of the present invention, there is provided a method of raising fish comprising a step of feeding each of the fish per day with cysteamine or its salt-like compounds, or a cysteamine-containing composition described above, preferably via a feed. When the fish are at a developmental stage with an average body weight equal to or less than 500 g, the fish may suitably be fed with a feed comprising 30 to 60 ppm of the cysteamine or its salt like compounds, or 100 to 200 ppm of the cysteamine-containing composition. When the fish are at a developmental stage with an average body weight greater than 500 g, the fish may suitably be fed with a feed comprising 60 to 150 ppm of the cysteamine or its salt like compounds, or 200 to 500 ppm of the cysteamine-containing composition.

According to a fourth aspect of the present invention, there is provided a feed for fish comprising a cysteamine containing composition. The composition may be used as feed additive. The composition may comprise substantially 1 to 95 wt % cysteamine having the chemical formula of NH₂—CH₂—CH₂—SH or its salt-like compounds. Suitably, the composition may comprise 1 to 80 wt % of a carrier. The carrier may be selected from a group including cyclodextrin or its derivatives.

According to a fifth aspect of the present invention, there is provided a method of preparing a fish feed described above comprising a step of mixing a cysteamine-containing composition with a basal feed material.

### DETAILED DESCRIPTION OF THE PRESENT INVENTION

The present invention is based on the demonstration that cysteamine or its salt like compounds, and/or a cysteamine containing composition when ingested by aquatic animals such as fish has activity in at least increasing body weight thereof. Prior to this finding, there was no suggestion or sufficient indication that cysteamine might have such activity in fish.

It has been found that similar to mammals, the secretion of growth hormones is pulsatile in fish. The structure of somatostatin (SS) in fish is found to be similar to mammals in that the somatostatin also inhibits the release of growth hormones in fish. It is known that the growth hormones regulate fish's metabolic and nutritional assimilation and cause growth and gain in their body weight. Studies have also shown that the growth hormones promote protein synthesis and enhance a positive nitrogen balance in the body of the fish.

Growth hormone receptors (GHR) in fish are distributed widely in different tissues, such as the liver, brain, gonads, bronchia, intestines and kidneys. In gonads, the growth hormones and growth hormone receptors modulate the level of steroid, leading to the promotion of the development of sperms and eggs. The role of the growth hormones and growth hormone receptors in bronchia, intestines, and kidneys is to regulate osmotic pressure in a fish's body. It is believed that an increase in the growth hormones in the intestines can affect the absorption of nutrition, and increase the concentration of amino acids in circulation, that leads to an increase of the feed conversion efficiency. It has also been found that the concentration of the growth hormone receptors in other tissues of fish accounts for about 3 to 6% of that in the liver. However, the binding activity of the growth hormones and growth hormone receptors in the liver is the same as in other tissues.

As illustrated, the growth hormones in fish promote growth and regulate osmotic pressure and these are mediated through insulin growth factor (IGF-1). In the present invention, the mechanism of cysteamine and/or the cysteamine-containing composition aims to deplete somatostatin in fish, so that the concentration of the growth hormones can be increased to facilitate growth. It is to be noted that the growth hormones are produced within the body of the fish and are not exogenous growth hormones.

It is believed that cysteamine having a physiological activity acts as a growth stimulator. Natural cysteamine is a part of coenzyme A (also known as COA-SH or CoA) which is a coenzyme pattern of pantothenic acid. In the course of metabolism, coenzyme A acts as the carrier of dihydrosulfuryl or variants of hydrosulfuryl which is linked with the hydrosulfuryl of coenzyme A. Experiments performed on other warm-blooded vertebrate animals such as pigs, cattle, fowls, goats and rabbits have shown that cysteamine can deplete somatostatin. During the making of the present invention, it is unexpectedly found that cysteamine can similarly deplete somatostatin in fish. It was previously believed that cysteamine was effective in depleting somatostatin significantly in mammalian animals and poultry only in practice. The depletion of somatostatin increases the level of growth hormones in the blood of the fish which at the same time raises the level of various other growth stimulating factors including [insulin-like growth factor I (IGF-I)] and insulin. The growth hormones are believed to directly stimulate the development of the physiology of various tissues as explained.

With the increase of these various growth-promoting factors, the digestive metabolic rate of the fish is correspondingly increased. It is understood that the general protein synthesis rate of the fish is accordingly increased, and thus their body weight is caused to increase more rapidly.

Various experiments have been conducted to demonstrate that administering a diet (or feed) comprising a cysteamine containing composition increases growth and body weight in fish, one experiment of which is described in detail as follows:

### Experiment

Background Information

The experiment was performed to demonstrate the effect on fish fed with a cysteamine-containing composition which is described in greater detail below. The species of fish used in the experiment is known as Megalobrama Amblycephala. There were two test groups and two control groups of the fish. Each group had 40 to 41 fish. The groups were kept in separate water tanks. The capacity of each of the water tanks was approximately 0.26M³. The water tanks were equipped with an automatic temperature control system, the water temperature being maintained at around 25 to 26° C. The water tanks were also equipped with a circulation system via which water in the water tanks are kept fresh by replacing with fresh river water at regular intervals.

Materials

A. Cysteamine-Containing Composition

The cysteamine-containing composition used in this experiment comprised 30 wt % cysteamine, 20 wt % of inclusion host compound materials and coating materials, 26 wt % of fillers, 23.9 wt % of disintegrants and binders and 0.1 wt % flavoring and smelling agents. The specific requirements for a workable cysteamine-containing composition are further explained later in the description.

B. Premix Material

A premix material is an intermediate mixer comprising the cysteamine-containing composition. The premix material facilitates subsequent mixing with a basal feed material. Ingredients for preparing the premix material may be selected from a group of suitable food materials including amino acids, salts, phosphorous and cornmeal. The premix material comprises from 10 to 20 wt % of the cysteamine containing composition although a wider workable range of 1 to 25 wt % may also be used.

C. Basal Feed

A basal feed used in the experiment comprises approximately 20 wt % rape seed, 15 wt % cotton seed, 15 wt % soybean, 15 wt % fish meal, 10 wt % wheat bran, 19 wt % wheat feed meal, 5 wt % minerals, 0.5 wt % binder, and 0.5 wt % vitamins. However, other suitable ingredients may be used.

D. Final Feeds

A final feed comprises a basal feed mixed with for example the cysteamine-containing composition and the premix material. In the experiment, identical final feed types A1 and A2 are used to feed the two test groups (Groups I and II) of fish. The final feed types A1 and A2 were prepared by mixing suitable amounts of the premix material comprising the cysteamine-containing compound and the basal feed. In particular, the final feed types A1 and A2 were formulated comprise approximately 200 ppm of the cysteamine-containing composition, or 60 ppm cysteamine. However, a final feed in practice may comprise a workable range of 100 to 200 ppm of the cysteamine-containing composition, or 30 to 60 ppm cysteamine. In practice, a final feed which has these ranges of concentration of cysteamine-containing composition and/or cysteamine are particularly suitable for fish with a body weight equal to or less than 500 g. For fish with a body weight greater than 500 g, a final feed preferably comprises 200 to 500 ppm of the cysteamine-containing composition, or 60 to 150 ppm cysteamine. Trace amount of feed concentrate and/or feed supplement may also be included to enhance and balance the nutritional value of the final feed.

In practice, when a premix is not used, the cysteamine-containing composition may be mixed directly with a basal feed.

The two control groups (Groups I and II) were fed with identical final feed types B1 and B2 to which no cysteamine-containing composition was added.

The only difference between the final feed types A1 & A2 and B1 & B2 is that the former comprised the desired amount of the cysteamine-containing composition.

Procedure

The experiment was performed during the period from 5 October 2001 to 17 Nov. 2001. The body weight of each of the four groups of fish was measured before and after the experiment. The number of fish that died during the experiment was recorded. The amount of feed consumed by the four groups of fish was also recorded.

Results and Discussions

Table 1 summarizes the results of the experiment.

TABLE 1
The four groups of fish before and after the experiment

| | Feed type | | | |
|---|---|---|---|---|
| | A1 | A2 | B1 | B2 |
| | Fish group | | | |
| | Group I | Group II | Group I | Group II |
| | (test) | (test) | (control) | (control) |
| Before experiment | | | | |
| Date | 5 Oct 2001 | 5 Oct 2001 | 5 Oct 2001 | 5 Oct 2001 |
| Number of fish | 41 | 40 | 40 | 41 |
| Total weight | 289.7 | 183.2 | 207.6 | 223.1 |
| (g) | | | | |
| Average weight | 7.06 | 4.58 | 5.19 | 5.44 |
| per fish (g) | | | | |
| After experiment | | | | |
| Date | 17 Nov 2001 | 17 Nov 2001 | 17 Nov 2001 | Nov. 17, 2001 |
| Number of fish | 41 | 40 | 39 | 41 |
| Total weight (g) | 558.9 | 403.0 | 419.9 | 381.5 |
| Average weight | 13.6 | 10.10 | 10.77 | 9.3 |
| per fish (g) | | | | |
| Feed consumption | 630.2 | 582.3 | 594.6 | 595.0 |
| Increase in | 269.2 | 219.8 | 212.3 | 222.4 |
| total weight (g) | | | | |
| Feed conversion | 2.34 | 2.65 | 2.80 | 2.68 |
| efficiency | | | | |
| Number of dead | 0 | 0 | 3 | 3 |
| fish | | | (7.5 g each) | |
| Survival rate (%) | 100 | 100 | 92.5 | 92.7 |

In the control Group I, since three fish died in the experiment, two spare fish of similar body weight were added to replace two of the dead fish. In the control Group II, three fish died in the experiment and three spare fish of similar weight were added to replace all three dead fish.

As shown in Table 1, the total body weight of the two test groups (Groups I and II) of fish before and after the experiment were 472.9 g [=289.7+183.2] and 961.9 g [558.9+403.0] respectively. There was therefore a gain of 489.0 g in total body weight that translated to approximately 103% increase in total body weight. The total body weight of the two control groups (Groups I and II) of fish before and after the experiment was 430.7 g [207.6+223.1] and 801.4 g [419.9+381.5] respectively. There was therefore a gain of 370.7 g in total body weight that translated to approximately only 86% increase in total body weight.

The average body weight of the two test groups (Groups I and II) of fish before and after the experiment were 5.84 g and 11.88 g respectively. There was therefore a gain of 6.03 g in average body weight that translated also to approximately 103% increase in average body weight. The average body weight of the two control groups (Groups I and II) of fish before and after the experiment were 5.32 g and 10.02 g respectively. There was therefore a gain of 4.70 g in average body weight that translated to approximately only 88% increase in average body weight. It is illustrated that the fish in the test groups grew more rapidly by at least 15% in terms of gain in body weight.

Thus, it can be concluded that fish fed with a feed comprising the cysteamine-containing composition can grow significantly more rapidly.

It is also found that the two test groups of fish have feed conversion efficiencies of 2.34 and 2.65. The two control groups of fish have feed conversion efficiencies of 2.80 and 2.68. Relatively low feed conversion efficiency suggests that a smaller amount of feed is required to produce a unit of body weight. It is obvious that the fish in the test groups are more efficient in converting the feed into their body weight.

Thus, it can be concluded that fish fed with a feed comprising the cysteamine-containing composition can convert and assimilate feed into their body more efficiently, and that the cysteamine-containing composition of the present invention can improve growth thereof and in particular increase their body weight.

It is to be noted that the condition in the water tanks was generally similar to those in aquaculture in the industry. Nevertheless, the condition was relatively crowded when compared to that in the wild. It is therefore not unusual that some fish in aquaculture would die in such environment due to diseases or overcrowding. However, no fish in the two test groups died during the experiment but six fish died in the two control groups. There is clear evidence that fish fed with the cysteamine-containing composition in aquaculture have better general health and in particular higher survival rate (or lower death rate). This is important because increasing the survival rate means higher output that translates to higher production efficiency.

While the cysteamine-containing composition used in the above experiment was made of the ingredients as described above, a cysteamine-containing composition made according to the following requirements will achieve a similar result. The two main ingredients in the composition are 1 to 95 wt % of cysteamine (or its salts, for example, cysteamine hydrochloride, or other pharmaceutically acceptable acid addition salts thereof) and 1 to 80 wt % of a carrier which is an inclusion compound host materials composition. The chemical formula of cysteamine is HSCH₂CH₂NH₂. The term “cysteamine” referred hereinafter means cysteamine and/or its salt-like compounds.

Cysteamine and its salt like compounds are well known in the chemical literature. The general chemical formula of a cysteamine salt is C₂H₇NS.X, where X may be HCl, H₃PO₄, bitartrate, salicylate, etc. The cysteamine used is preferably of pharmaceutically acceptable standard and the content of carbon, hydrogen, nitrogen and sulfur therein are substantially 31.14 wt %, 9.15 wt %, 18.16 wt % and 41.56 wt % respectively.

While the workable content of cysteamine in the cysteamine—containing composition ranges from 1 to 95 wt %, a preferable range of 1 to 75 wt % and a more preferable range of 1 to 40 wt % of cysteamine may be used. Cysteamine is one of the main active ingredients of the cysteamine-containing composition. However, it has been identified that if the content of cysteamine in the cysteamine-containing composition exceeds 95 wt %, mixing the composition with a basal feed would be rather difficult.

The carrier or the inclusion compound host materials composition for stabilizing cysteamine comprise mainly cyclodextrin and/or its derivatives which are selected from a group included methyl β-cyclodextrin (M-D-CD), hydropropyl β-cyclodextrin (HP-D-CD), hydroethyl β-cyclodextrin (HE-D-CD), polycyclodextrin, ethyl β-cyclodextrin (E-D-CD) and branched cyclodextrin. The general chemical formula cyclodextrin is (C₆O₅H₉)ₙ.(C₆O₅H₉)₂ and the structural formula is as follows.

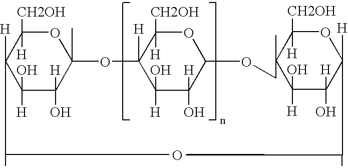

where α-CD n=4; β-CD n=5; γ-CD n=6.

(Cyclodextrin is a cyclic oligomer of alpha-D-glucopyranose.)

It is worthwhile to note that the β-CD form of cyclodextrin is preferably used because the internal diameter of its molecule is about 6-8A which makes it a particular suitable candidate as an inclusion compound host material for preparation of the cysteamine-containing composition, which involves the use of an inclusion process. The term “cyclodextrin” referred hereinafter means cyclodextrin and/or its derivatives. Any derivatives of cyclodextrin which has the property of stabilizing and protecting cysteamine from degradation may be used. For example, any one of the groups of cyclodextrin or its derivatives mentioned above may be used. While the workable content of the carrier in the cysteamine-containing composition ranges from 1 to 80 wt %, a preferable workable range of 1 to 60 wt % and a more preferable workable range of 10 to 40 wt % of carrier may also be used. The actual amount of carrier used will depend on the actual content of the cysteamine used in preparing the cysteamine-containing composition.

The cysteamine-containing composition may also comprise 1 to 90 wt % of fillers although a preferable workable range of 1 to 60 wt % and a more preferable workable range of 1 to 40 wt % of the fillers may also be used in the composition. The actual content will depend on the actual amount of cysteamine and inclusion compound host materials used.

The fillers may be selected from a group including powdered cellulose, starch and calcium sulfate (e.g. CaSO₄.2H₂O). It is to be noted that if the content of the fillers exceeds 90 wt % in the cysteamine-containing composition, the content of the main active ingredients will thus be reduced, and the cysteamine-containing composition may become ineffective as desired.

The cysteamine-containing composition may also comprise 5 to 50 wt % of disintegrants and binders although a preferable workable range of 10 to 90 wt % and a more preferable workable range of 15 to 35 wt % may also be used. The actual content will depend on the actual amount of cysteamine, the carrier and other ingredients used.

The binders and disintegrants may be selected from a group including hydropropyl starch, microbial alginate, microcrystalline cellulose and starch. It has been identified that if the content of the disintegrants and binders in the composition is less than 5 wt %, granules of the composition produced will lack the required hardness. In addition, manufacturing of the composition would become very difficult. If however the content of the disintegrants and binders is more than 50 wt %, the resulting composition will have excessive hardness, this is especially so if the content of binders represents a large portion of the mixture of the disintegrants and binders. This will result in difficult absorption of the composition by the intestines of the fish.

The cysteamine-containing composition may also comprise 0.05 to 0.3 wt % of flavoring and smelling agents which may be a flavoring essence.

The cysteamine-containing composition may also comprise 1 to 20 wt % of coating materials although a preferable workable range is 1 to 15 wt % and a more preferable workable range is 2 to 10 wt %. The actual content will depend on the actual amount of cysteamine, the carrier and the other ingredients used. The coating materials are in a solid state at normal room temperature conditions, and preferably enteric which allows dissolution in an alkaline environment such as in the intestines. The coating materials may be selected from a group including cellulose acetate phthalate, starch acetate phthalate, methyl cellulose phthalate, glucose or fructose derivatives from phthalic acid, acrylic and methacrylic copolymers, polymethyl vinyl ether, partly esterified substance of maleic anhydride copolymers, shell-lac and formogelatine. The coating materials can remain un-dissolved in an acidic environment from pH 1.5 to 3.5. It has been identified if the content of the coating materials is less than 1 wt %, granules of the composition may not be entirely covered by the coating materials which act as a protective layer. The cysteamine-containing composition may thus degrade before being absorbed by the intestines into the bloodstream of the animals and in the present context the fish in aquaculture. On the other hand, if the content of the coating materials exceeds 15 wt %, the active ingredients in the composition may not effectively be released from the composition. Thus, the intended regulation of growth and health would be not achieved. In any event, it has been established that a feed comprising 100 to 500 ppm of the composition (or 30 to 75 ppm cysteamine) is effective, when used in feeding fish in aquaculture, in improving growth and/or health thereof, and in particular increasing their body weight.

The cysteamine-containing composition for use in the context of the present invention is in the form of small granules each of which has a preferable diameter of substantially 0.28 to 0.90 mm. These granules are prepared using a micro-encapsulation method. The method involves using a macromolecular substance having inclusion property. One substance which may be used is the carrier (which comprises mainly cyclodextrin) described above. The carrier is a macromolecular substance which acts as a molecular capsule to engulf the molecules of cysteamine, whereby cysteamine in the composition is protected and insulated from light, heat, air and moisture of the surroundings. The stability of cysteamine is thus preserved. The carrier used in the micro-encapsulation method is preferably a cyclic polysaccharide compound having 6 to 12 glucose molecules, which is produced by reacting cyclodextrin glycosidtransferase and starch in the presence of Bacillus. Various studies using acute, sub-acute and chronic toxic tests have shown that the macromolecular substance is non-toxic.

Subsequent to the micro-encapsulation process, each granule may be coated with at least one and preferably a plurality of layers of the coating materials described above. The following provides a more detailed description of one embodiment of a method of preparing the cysteamine containing composition according to the present invention.

In a jacketed reactor lined with polytetrafluoroethylene and equipped with a polytetrafluoroethylene-coated stirrer, 4080 g of 75 wt % cysteamine hydrochloride solution in ethanol is added with mainly nitrogen being the atmosphere. The purity, melting point and burning residue of the cysteamine used are preferably 98% or above, 66 to 70° C. and 0.05% or below respectively. 1200 g β-cyclodextrin is then added into the reactor similarly under the protection of nitrogen gas. (The quality of β-cyclodextrin is in accordance with the requirements for a food additive. In particular, the dry basis purity is more than 98%; the weight loss by drying is less than 10.0%; the burning residue is less than 0.2%; the content of heavy metal is less than 10 ppm; the arsenic content is less than 2 ppm.)

The mixture is then heated for 3 hours at 40° C. Heating is then stopped and stirring continues for two hours thereafter, products resulted therefrom are then grounded and sieved through a screen (e.g. 40-mesh) filter after the products have been vacuum dried at a temperature of 40-50° C. All parts of the equipment, which may come in contact with the ingredients of the composition, should preferably be made of stainless steel. In a tank-type mixer, 4200 g (on dry basis) of the cysteamine which has undergone the inclusion process as described, 2600 g of the fillers, and 1200 g of the disintegrants and 1700 g binders are added under the protection of a dry surroundings. These ingredients are then thoroughly mixed, and a suitable amount of anhydrous ethanol may be added and then mixed therewith. The resulting mixture presents a soft material with moderate hardness, so that it can be shaped into a ball by a light hold of palms. The ball-shaped resulting mixture may then be broken up by a light touch.

After the mixture is pelleted by a granulator under the protection of nitrogen, the small granules resulting therefrom are immediately introduced to a fluid-bed dryer, and are then dried at the temperature of 40-50° C. in a substantially vacuum environment. Enteric coating materials are then prepared by a method with the following formulation: cellulose acetate phthalate 8.0 g, polyethylene glycol terephthalate 2.4 ml, ethyl acetate 33.0 ml and isopropyl acetate 33.6 ml. The resultant granules obtained above are uniformly coated under the protection of nitrogen with at least one layer but preferably a plurality of layers of the enteric coating materials described above. In other words, the coating materials exhibit a multi-layer structure in each resultant granule of the composition. The enteric coating materials are dissolvable only at an alkaline environment. This can prevent the cysteamine from prematurely escaped from the composition while it is still in the stomach of the animal. Cysteamine can adversely stimulate gastric mucous of the stomach of the animals. The resultant granules of the cysteamine-containing composition are then dried completely in a substantially vacuum dryer at a temperature of 40 to 50° C. Then, all solvents are removed.

The resultant granules are then allowed to cool to room temperature, the micro-capsula were mixed with a suitable amount of flavoring and smelling agents by a cantilever double helix blender. The cysteamine-containing composition is a microcapsule with its interior having cysteamine hydrochloride and cyclodextrin, and with its exterior coated with the enteric coating materials. The composition produced will exhibit small granular (or micro-particulate) shape having smooth surface, good flow property, and is easy to be blended with various animal feeds. The diameter of each granule of the composition is preferably 0.28 to 0.90 mm. The composition also has excellent stability. It has been found that after the composition is packaged with sealed plastic bags and stored for one year in a cool, dark and dry place, their properties remain unchanged. Therefore, they meet the requirements for a feed additive.

The composition having the particular construction described above has a number of functional advantages over cysteamine by itself. Firstly, the activity of the cysteamine contained in the composition is preserved after it has been produced. This is important, as feed additive such as the composition may be stored for a relatively long period of time before use. Secondly, the composition does not cause any noticeable side effects to the fish fed therewith. Thirdly, the activity of the composition is preserved not only during storage but more importantly until it reaches the intestines of the fish. Fourthly, the composition can be easily administered in large fish farms in aquaculture on a large-scale basis cost-effectively because the composition can be readily mixed with any suitable basal feed. No separate procedure or injection is needed at all.

The contents of each of the references discussed above, International Patent Publication no. WO02/48110 (application no. PCT/EP01/14628) and PRC Patent Publication no. 1358499 (application no. 00132107.2) and unpublished UK Patent Application no. 0203991.5, including the references cited therein, are herein incorporated by reference in their entirety. It is to be noted that numerous variations, modifications, and further embodiments are possible and accordingly, all such variations, modifications and embodiments are to be regarded as being within the scope of the present invention.

1. A method of raising fish, increasing body weight of fish and reducing a death rate of fish comprising:
(a) providing a fish feeding composition having substantially 1 to 95 wt % of cysteamine having the chemical formula of NH₂—CH₂—CH₂—SH or salts thereof, substantially 1 to 80 wt % of a carrier for said cysteamine, said carrier being in the form of an inclusion compound host material, said carrier being a side-effect reducer and/or a stabilizer for said cysteamine or salts thereof or for said composition, and, a coating material, said coating material being a protector for said cysteamine or salts thereof such that said composition remains effective until reaching an intestine of the fish,
(a) mixing said composition with a basal feed for said fish to form a final feed, and
(b) feeding the fish with said final feed;
wherein said final feed contains substantially 30 to 165 ppm of said cysteamine or salts thereof, or substantially 100 to 550 ppm of said composition.

2. The method of claim 1, wherein said mixing comprises directly mixing said composition with said basal feed.

3. The method of claim 1, wherein said mixing further comprises first preparing a premix material including said composition, and subsequently mixing said premix material with said basal feed to form said final feed.

4. The method of claim 3, further comprising preparing said premix material by mixing said composition with a food material selected from the group consisting of amino acids, salts, phosphorous, cornmeal and combinations thereof.

5. The method of claim 3, wherein said premix material has a content of 1 to 25 wt % of said composition.

6. The method of claim 3, wherein said premix material has a content of 10 to 20 wt % of said composition.

7. The method of claim 1, further comprising feeding the fish with said final feed when the fish is at a development stage when said fish have an average body weight equal to or less than 500 g, said final feed containing substantially 30 to 60 ppm of said cysteamine or salts thereof.

8. The method of claim 1, further comprising feeding the fish with said final feed when said fish is at a development stage when they have an average body weight equal to or less than 500 g, said final feed containing substantially 100 to 200 ppm of said fish feeding composition.

9. The method of claim 1, further comprising feeding the fish with said final feed when the fish is at a development stage when said fish have an average body weight greater than 500 g, said final feed containing substantially 60 to 150 ppm of said cysteamine or salts thereof.

10. The method of claim 1, further comprising feeding the fish with said final feed when the fish is at a development stage when said fish have an average body weight greater than 500 g, said final feed containing substantially 200 to 500 ppm of said composition.
